(19) United States
(12) Patent Application Publication
(10) Pub. No.: US 2004/0100106 A1
(43) Pub. Date: May 27, 2004

(54) Resilient assembly for vehicle latch mechanism

(76) Inventor: Sidney Edward Fisher, Worcestershire (GB)

Correspondence Address: CARLSON, GASKEY & OLDS, P.C., 400 WEST MAPLE ROAD, SUITE 350, BIRMINGHAM, MI, 48009, US

(21) Appl. No.: 10/677,759

(22) Filed: Oct. 2, 2003

(30) Foreign Application Priority Data
Oct. 2, 2002 (GB) 0222905.2

(51) Int. Cl. E05C 3/02

(52) U.S. Cl. 292/229

(57) ABSTRACT

A resilient assembly for a vehicle door latch assembly includes two retainers that substantially face each other and a resilient member supported by seats in the retainers. The resilient member is biased to resist a tensile force applied to load application features at the ends of the retainers as the seats of the retainers are moved toward each other. The retainers allow the amount of preload force applied to the resilient assembly to not be limited by the physical characteristics of the resilient member.

### REFERENCE TO RELATED APPLICATIONS

The present invention claims the benefit of United Kingdom (GB) patent application number 0222905.2, filed Oct. 2, 2002.

### TECHNICAL FIELD

The present invention relates to a resilient device for use in a latch mechanism for doors of passenger vehicles, such as cars.

### BACKGROUND OF THE INVENTION

Resilient members, such as helical tension springs, are well known and are used in many different applications. GB2328241 shows examples of where helical tension springs are used within door latches. Typically, the tension spring comprises a series of wire coils with each end of the wire being formed into a hook. The end hooks act as an undesirable design limiting feature for the tension springs because the tension spring tends to break in the end hook area.

It is also known to preload tension springs before incorporating them into a device.

As the coils are wound, the wire itself is twisted so that the finished tension spring, when unloaded, has adjacent coils in contact with each other. In order to stretch the spring, the stretching forces must first overcome the preload force before the spring will extend. In other words, the spring will not extend if a load less than the preload is applied to the end hooks of the spring.

While the preload force on the spring can be varied within certain limits, there is an upper limit to the amount of possible preload for any spring configuration having a given set of characteristics (e.g., wire diameter, wire material, coil diameter, etc.).

There is a desire for an assembly that overcomes the end hook breakage and preload limits experienced in currently known resilient member structures.

### SUMMARY OF THE INVENTION

The present invention is generally directed to an assembly, such as a vehicle door latch assembly, that incorporates a resilient assembly having a resilient member. According to one embodiment of the invention, a door latch assembly includes a support having a release lever moveable about a release lever axis and a lock lever moveable about a lock lever axis. The release lever and the lock lever are connected by a resilient assembly to move the levers between a latched unlocked position, a latched locked position and an unlatched position. The resilient assembly has a first retainer with a first seat and a first load application feature and a second retainer with a second seat and a second load application feature. The first and second seats substantially face each other. The resilient assembly further includes a resilient member, such as a spring, that is supported between the first and second seats and positioned between the first and second load application features. Movement of the first and second seats toward each other by application of a tensile force onto the first and second load application features is resisted by the resilient member. As a result, the resilient assembly acts resiliently when tensile force is applied to the assembly to permit the release lever to move relative to the lock lever when the assembly is in the unlatched position.

Another embodiment of the present invention is directed to a resilient assembly having a first retainer with a first seat and a first load application feature and a second retainer with a second seat and a second load application feature. The first and second seats substantially face each other. The resilient assembly further including a resilient member supported between the first and second seats and positioned between the first and second load application features. Movement of the first and second seats toward each other by application of a tensile force on the first and second load application features is resisted by the resilient member. One of the first or second retainers includes a recess for receiving at least a part of the resilient member, and the recess includes an additional seat, wherein the resilient means is mounted between the seat and the additional seat.

According to another embodiment of the invention, a resilient assembly having a first retainer with a first seat and a first load application feature and a second retainer with a second seat and a second load application feature. The first and second seats substantially face each other. The resilient assembly further includes a resilient member supported between the first and second seats and positioned between the first and second load application features. Movement of the first and second seats toward each other by application of a tensile force on the first and second load application features is resisted by the resilient member. The first and/or second retainer may be made from a sheet material, such as sheet metal (e.g., sheet steel).

### BRIEF DESCRIPTION OF THE DRAWINGS

The invention will now be described, by way of example only, with reference to the accompanying drawings in which:

FIG. 1 illustrates a front view of one embodiment of the inventive resilient assembly in a relaxed condition according to the present invention;

FIG. 2 illustrates a resilient assembly of FIG. 1 in a tensioned condition;

FIG. 3 illustrates a side view of the resilient assembly shown in FIG. 2,

FIG. 4 illustrates one embodiment of a retainer in the resilient assembly of FIG. 1;

FIG. 5 illustrates relative longitudinal positions of the retainers of FIG. 1 during assembly;

FIG. 6 illustrates longitudinal relative positions of the retainers of FIG. 1 after assembly;

FIGS. 7 and 8 illustrate views of further embodiments of retainers in positions corresponding to FIGS. 5 and 6, respectively;

FIG. 9 is a diagrammatic representation of a latch assembly incorporating the resilient assembly of FIG. 1 in a locked latched condition;

FIG. 10 is the latch assembly of FIG. 9 in an unlocked latched condition or an unlocked latched condition; and

FIG. 11 shows the latch device of FIG. 9 in an unlatched condition.

### DETAILED DESCRIPTION OF THE EMBODIMENTS

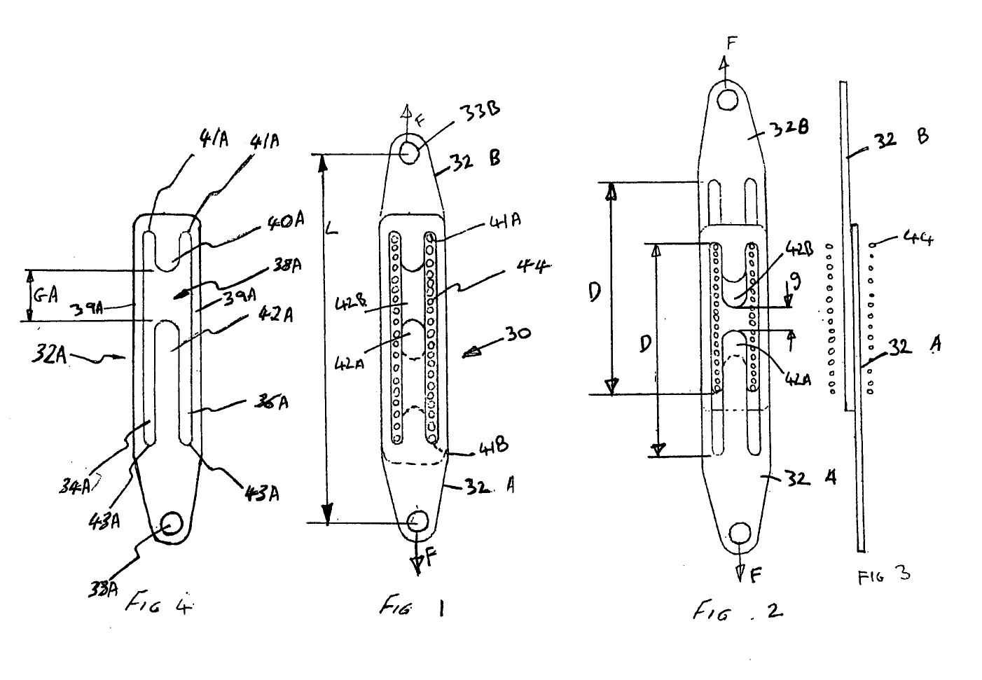

FIGS. 1 to 4 illustrate a resilient assembly 30 according to one embodiment of the invention. In this embodiment, the resilient assembly 30 has first and second spring retainers 32A and 32B and a resilient member 44 in the form of a helical compression spring. Note that the present invention is not limited to an assembly using helical compression springs as the resilient member 44. Thus, for example, a cylindrical tube or solid blocks of resilient material could replace the spring 44 as the resilient member. It will be appreciated that the terms “resilient member,” “spring,” “spring retainer,” and “spring seat” do not limit the present application to using helical compression springs, or even springs in general, as the resilient member.

In the embodiment shown in FIGS. 1 through 4, the spring retainers 32A and 32B are identical and are formed via any known process (e.g., via stamping) from a sheet material, such as sheet metal (e.g., sheet steel). The retainer 32A is generally elongate and has a hole 33A at one end. During use, the hole 33A acts as a load application feature (in conjunction with hole 33B) to apply tensile and compressive loads to the resilient assembly.

There is also provided an H-shaped recess 38A defined by edges 39A and projections 40A and 42A. In the illustrated embodiment, one of the projections 42A is longer than the other projection 40A. The recess 38A defines spring seats 43A at the ends of the longer legs of the H-shaped recess, and spring seats 41A at the end of the shorter legs of the H-shaped recess. The distance between the spring seats 41A and 43A is defined as D. From the perspective shown in the Figures, the left hand portion of the H-shaped recess 38A defines a slot 34A of length D and the right hand portion of the H-shaped recess 38A defines a slot 36A also of length D. The free, uncompressed length of the spring 44 is larger than D.

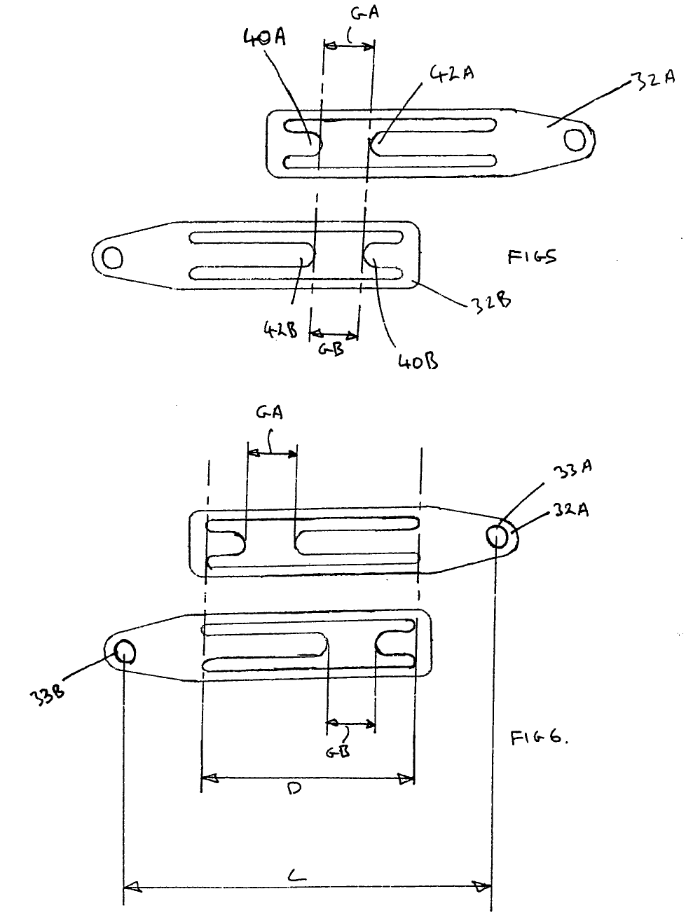

It can be seen from FIGS. 1 and 3 that the resilient assembly 30 is assembled with the spring retainers being placed against each other in a substantially facing relationship but having their appropriate holes 33 disposed remotely from each other. In this way, the first slot 34A of the first retainer 32A is aligned with the first slot 36B of the second retainer 32B, and the second slot 34B of the first retainer 32B is aligned with the second slot 36A of the second retainer 32A.

It can also be seen that the first spring seat 41A substantially faces the second spring seat 41B, thus allowing the spring 44 to be positioned between the two spring seats 41A and 41B. Furthermore, the spring 44 and the spring seats 41A and 41B are positioned between the holes 33A and 33B; that is, the holes 33A and 33B are substantially in line with the spring seats 41A and 41B and are also in line with the spring 44.

Diametrically opposing portions of the coils of the spring 44 sit in appropriate slots 34 and 36 of the retainers 32A and 32B. Because the free, uncompressed length of the spring 44 is larger than D, it is apparent that the resilient assembly 30 as shown in its “rest” position of FIG. 1 is preloaded. Thus, when the resilient assembly is put under tension by applying a tensile load to the holes 33A and 33B in the directions of arrow F, the resilient assembly will only start to extend once the preload force in the spring 44 has been overcome.

Similarly, if a compressive force is applied to the holes 33A and 33B, the resilient assembly will only start to compress once the preload force has been overcome.

FIG. 2 shows a resilient assembly that has been extended by the application of an appropriate force. It can be seen that while the resilient assembly 30 as a whole has been extended, the spring 44 has actually been compressed due to the action of the projections 40A,B and 42A,B on the spring 44.

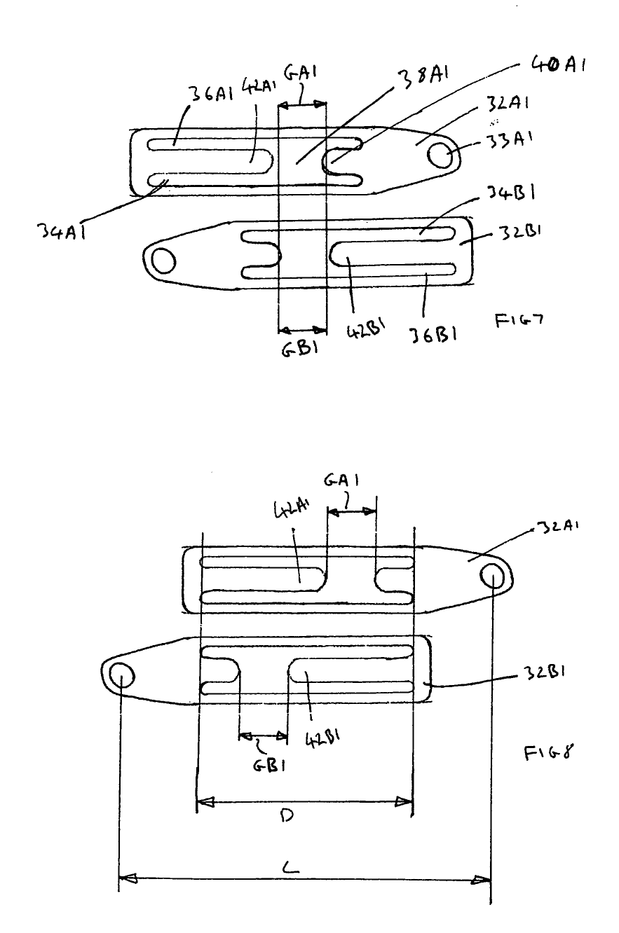

FIG. 4 shows a gap GA between the ends of projections 40A and 42A. As mentioned above, one of the projections 40A is shorter than the other projection 42A. This is advantageous because when the resilient assembly 30 is in the rest position, as shown in FIG. 1, the longer projection 42A overlaps with the shorter projection 42B, thus ensuring that spring 44 remains in its correct position. This is most easily seen in FIG. 6, which shows an exploded view of the retainers in their correct longitudinal position when the resilient assembly 30 is in its rest condition. It can be seen that the spring seats 41A,B are aligned and that gap GA is offset from gap GB. The figure shows the holes 33A and 33B spaced apart by distance L which, in view of FIG. 1, corresponds to the at rest working length of the resilient assembly 30.

When the resilient assembly is extended as shown in FIG. 2, the gap g between the ends of the projections 42A and 42B is smaller than the gap GA. Thus, even when extended, the spring 44 is unlikely to escape from the recesses 38 through gap g.

The retainers 32A and 32B and spring 44 are assembled as follows to form the resilient assembly 30. FIG. 5 shows an exploded view of the retainers 32A and 32B in the correct longitudinal relative position for incorporation of the spring 44. It can be seen that when retainer 32B is placed on top of retainer 32A in this longitudinal position, gap GA aligns with gap GB. Under these circumstances, projection 40A faces projection 42B and projection 42A faces projection 40B. As a result, one end of the spring 44 can be threaded onto adjacent projections 40A/42B via gap GA/GB, and the spring 44 can then be compressed so that its other end can be threaded onto adjacent projections 42A/40B. After the spring 44 has been threaded and released, the resilient assembly 30 will spring to its at rest working length L.

FIGS. 7 and 8 show further embodiments of retainers according to the invention. In this embodiment, the retainer 32B1 is identical to retainer 32A1. Further, the external profile and the end hole of retainer 32A1 is identical to retainer 32A described above and the shape of the recess 38A1 is identical to the shape of recess 38A described above. However, it should be noted that the positions of the long and short projections 42A1 and 40A1 have been reversed when compared with retainer 32A described in the previous embodiment. More particularly, the short projection 40A1 in this embodiment is near hole 33A1, and the long projection 42A1 is remote from the hole 33A1.

The spring 44 can be assembled onto retainers 32A1 and 32B1 by aligning gaps GA1 and GB1. FIG. 8 shows that in this case, when the resilient assembly is at a rest condition, gap GA1 sits to the right of gap GB1 when considering FIG. 8. The corresponding position of gaps GA and GB of FIG. 6 should be contrasted with FIG. 8.

By arranging the long and short projections in this manner, the long projection 42A1 will always overlap with the long projection 42B1 under any tensile load, thus ensuring that spring 44 cannot escape when the resilient assembly 30 is under tensile load.

It can be seen that the present invention provides for a resilient assembly 30 that can act in tension. The inventive device does not have the hooked ends of known tension springs and therefore does not suffer from breakage at the ends of the spring 44. Furthermore, the present application is not limited by the physical characteristics of the resilient member.

It can be seen that, where a preload is required, the amount of preload is no longer limited by the manufacturing techniques used to make the spring 44. Rather the preload is determined by the relationship between the free, uncompressed length of the spring 44 and the distance between the spring seats of the spring retainer.

Note that in further embodiments it is possible to have differing spring retainers where the distance between the spring seats in one retainer is defined as D and the distance between the corresponding spring seats on the second retainer is greater than D. In this way, there will be lost motion between the second retainer and the spring 44. Nevertheless, when the resilient means is preloaded, and once the lost motion has been taken up, the device as a whole is preloaded.

In further embodiments, the distance between the spring seats on both retainers could equal the free length of the spring. Such a device would have no preload and also no lost motion. In other embodiments, the distance between the spring seats on both retainers could be larger than the free length of the spring. Such a device would have lost motion between the retainers, and even when the lost motion is taken up, there would be no preload.

It should be noted that the resilient assembly, in addition to acting in tension, can act in compression. However, if a compressive load that is less than the preload in the spring is applied to the resilient assembly, the resilient assembly will not compress.

It will be appreciated that each end of the spring loosely abuts with its corresponding spring seat and is not glued or otherwise permanently attached to the spring seat. Indeed, where the resilient assembly acts in both compression and tension, the spring may disengage from the spring seats.

It will be apparent that with sufficient tension applied to holes 33A and 33B, spring 44 may become coil bound and the resilient assembly 30 may in effect become a solid link. This can be advantageous under certain circumstances. Furthermore, with sufficient compressive force applied to holes 33A and 33B, the spring 44 may again become coil bound and again the resilient assembly may act as a solid link in compression. This can be advantageous in certain circumstances.

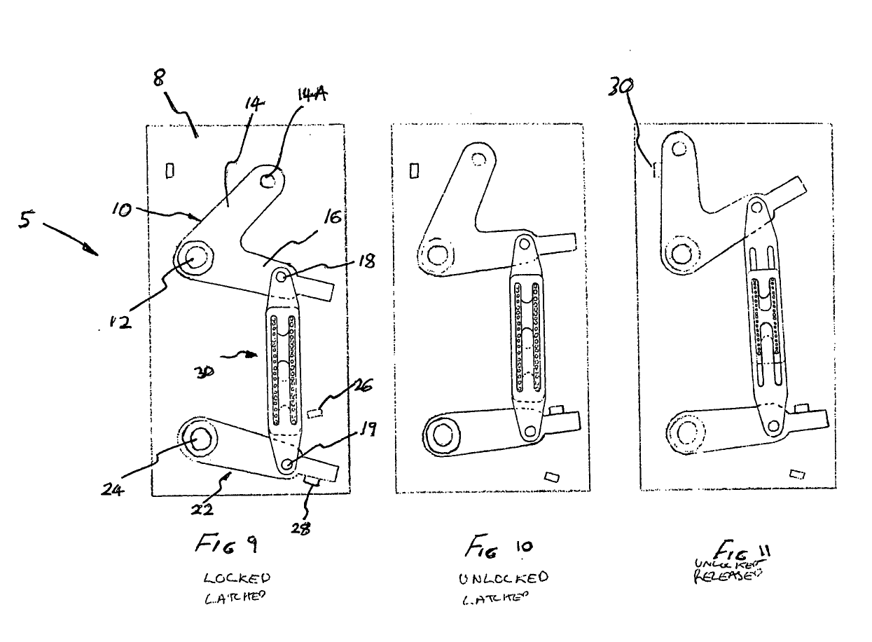

The use of the present invention in a door latch assembly will now be described with respect to FIGS. 9 through 11. FIGS. 9 through 11 illustrates part of a vehicle door latch mechanism in various stages of operation, where FIG. 9 shows the mechanism in a locked and latched position, FIG. 10 shows the mechanism in an unlocked and latched position, and FIG. 11 shows the mechanism in an unlocked and released position. The resilient assembly in the vehicle door latch mechanism is preloaded, and a force used to move a block arm 22 from the unlocked position shown in FIG. 10 to the locked position shown in FIG. 9 is less than the preload force in the resilient assembly 30. Thus, when the release lever 10 is moved from the position shown in unlocked position in FIG. 10 to the locked position shown in FIG. 9, the resilient assembly 30 acts as a solid link 5. The arrangement and action of most of the operating parts of the latch mechanism and their corresponding mounting structures in the door are of conventional construction well known to those skilled in the art.

However, a self-acting latching means incorporating the inventive resilient assembly includes a rotating claw or other latch which, in use, co-operates with a striker on a vehicle door post. The claw is retainable in a fully closed and first safety condition by a co-acting pawl. The pawl is linked to a latch release member, such as a release lever 10 having a bell crank form, that is moveable about a release lever axis 12 on a support 8. In this example, the support 8 is in the form of a chassis of the latch. One portion 14 of the release lever 10 is linked (via hole 14A) to a manually operable interior handle (not shown) of the door.

A second portion 16 of the release lever 10 is pivotally connected at 18 to the hole 33B at one end of the resilient assembly 30. The other end of the resilient assembly 30 is pivotally connected via the hole 33A at point 19 to a lock lever 22. The lock lever has a pivot 24 on the support 8.

As shown in FIGS. 9 and 10, the lock lever 22 is angularly displaceable between locked and unlocked positions, respectively. These positions are determined respectively by fixed upper and lower (as viewed in the drawings) stops 26, 28 on the support 8, which are abutted by opposite sides of the lock lever 22.

The lock lever 22 is provided with an overcenter spring (not shown), which urges the lock lever 22 into abutment with one or other of the stops 26, 28 once it has passed over the center point between the two stops so that the locking means operated by the lock lever 22 will not stay in an intermediate position between its locked and unlocked states.

Upon opening (release) of the latch, the release lever 10 is angularly displaced to a position determined by a stop 29 on the support 8, shown in FIG. 11. This continued rotation of the release lever 10, with the lock lever 22 abutted against the stop 26, causes an elongation of the resilient assembly 30.

The operational sequence of the mechanism in FIGS. 9 through 11 is as follows. As noted above and in the summary, the resilient assembly 30 is provided with a preload force, but without any lost motion between the spring retainers 32A and 32B. In FIG. 9, the release lever 10 has been moved to its extreme clockwise position as viewed in the drawings into a locked position. The movement of the release lever 10 in this direction causes the resilient assembly 30 to push the lock lever 22 positively into its locked position against the stop 28. The resilient assembly 30 has thus acted in compression. This operation leaves the door latched and locked.

FIG. 10 shows the release lever 10 moved counter clockwise to an intermediate neutral position. This allows unlocking, but not unlatching, of the door as the movement of the resilient assembly 30 pulls the lock lever 22 counter clockwise to the stop 26. Note that the resilient assembly 30 is strong enough to overcome the retaining force of the overcenter spring (not shown) without any deflection due to the preload forces in the resilient assembly 30. Thus, the device again effectively acts as a solid link when moving from the locked position shown in FIG. 9 to the unlocked position shown in FIG. 10.

To open the door, actuation of the door handle (not shown) moves the release lever 10 to its extreme counter clockwise position as shown in FIG. 11, freeing the pawl from the claw and allowing the door to unlatch for opening of the door. The resilient assembly 30 reacts against this motion of the release lever 10 while the lock lever 22 remains undisturbed against the stop 26. Once unlatched, the door handle is released and the resilient assembly 30 urges or assists in urging the release lever 10 back as far as its neutral position in FIG. 10 (i.e., the unlocked and latched position).

From the unlocked latched state shown in FIG. 10, locking the door entails rotating the release lever 10 clockwise to the position shown in FIG. 9. This causes the resilient assembly 30 to act in compression and push the lock lever 22 clockwise to the position shown in FIG. 9. Because of the preload force in the resilient assembly 30, the assembly 30 acts a solid link when moving from the position shown in FIG. 10 to the position shown in FIG. 9.

As a result, the present invention simplifies the design process for the latch since it is possible to design the resilient assembly with higher preloads than allowed in conventional resilient members.

It should be understood that various alternatives to the embodiments of the invention described herein may be employed in practicing the invention. It is intended that the following claims define the scope of the invention and that the method and apparatus within the scope of these claims and their equivalents be covered thereby.

1. A door latch assembly comprising:
a release lever movable about a release lever axis;
a lock lever moveable about a lock lever axis, wherein the release lever and the lock lever are movable between a latched unlocked position, a latched locked position, and an unlatched position; and
a resilient assembly connected between the release lever and the lock lever, the resilient assembly having
a first retainer having a first seat and a first load application feature,
a second retainer having a second seat and a second load application feature, wherein the first and second seats substantially face each other, and
a resilient member supported between the first and second seats and positioned between the first and second load application features, wherein the resilient member is biased to resist a tensile force applied to the first and second load application features that moves the first and second seat toward each other and to move the release lever relative to the lock lever when the lock lever and the release lever are in the unlatched position.

2. The door latch assembly of claim 1, wherein the resilient assembly acts in a non-resilient manner when the release lever and lock lever move from the latched unlocked position to the latched locked position.

3. The door latch assembly of claim 1, wherein the resilient assembly acts in a non-resilient manner when the release lever and lock lever move from the latched locked position to the latched unlocked position.

4. The door latch assembly of claim 1, wherein at least one of the first and second retainers includes a recess that receives at least a portion of the resilient member.

5. The door latch assembly of claim 4, wherein the recess includes an additional seat, and wherein the resilient member is mounted between at least one of the first and second seat and the additional seat.

6. The door latch assembly of claim 5, wherein at least one of the first and second seat and the additional seat hold the resilient member in a preloaded position.

7. The door latch assembly of claim 6, wherein the first retainer has the first seat and a first additional seat and the second retainer has the second seat and a second additional seat.

8. The door latch assembly of claim 7, wherein the first and second seats and the first and second additional seats are arranged to allow lost motion between one of the first and second retainer and the resilient member.

9. The door latch assembly of claim 7, wherein the first and second seats and the first and second additional seats are arranged to preload the resilient means.

10. The door latch assembly of claim 7, further comprising a first projection that projects from the first seat of the first retainer and a second projection that projects from the first additional seat of the first retainer, wherein the resilient member is mounted on the first and second projections.

11. The door latch assembly of claim 10, wherein the second retainer further comprises a first projection projecting from the second seat and a second projection projecting from the second additional seat, and wherein the resilient member is mounted on the first and second projections of the first and second retainers, wherein at least one of the first and second projections of the first retainer overlaps with at least one of the first and second projections of the second retainer.

12. The door latch assembly of claim 11, wherein said at least one of the first and second projections of the first retainer overlaps with at least one of the first and second projections of the second retainer when the release lever and the lock lever are in the unlatched position.

13. A resilient assembly, comprising:
a first retainer having a first seat and a first load application feature;
a second retainer having a second seat and a second load application feature, wherein the first and second seats substantially face each other; and
a resilient member supported between the first and second seats and having at least a portion received by a recess in at least one of the first and second retainers, wherein the resilient member is positioned between the first and second load application features, and wherein the resilient member is biased to resist a tensile force applied to the first and second load application features that moves the first and second seat toward each other.

14. The resilient assembly of claim 13, wherein the recess includes an additional seat, and wherein the resilient member is mounted between at least one of the first and second seat and the additional seat.

15. The resilient assembly of claim 14, wherein at least one of the first and second seat and the additional seat hold the resilient member in a preloaded position.

16. The resilient assembly of claim 14, wherein the first retainer has the first seat and a first additional seat and the second retainer has the second seat and a second additional seat.

17. The resilient assembly of claim 16, wherein the first and second seats and the first and second additional seats are arranged to allow lost motion between one of the first and second retainer and the resilient member.

18. The resilient assembly of claim 16, wherein the first and second seats and the first and second additional seats are arranged to preload the resilient means.

19. The resilient assembly of claim 14, wherein the first retainer further comprises a first projection that projects from the first seat and a second projection that projects from the additional seat, wherein the resilient member is mounted on the first and second projections.

20. The resilient assembly of claim 19, wherein the second retainer further comprises a first projection projecting from the second seat and a second projection projecting from the second additional seat, wherein the resilient member is mounted on the first and second projections of the first and second retainers.

21. The resilient assembly of claim 20 wherein at least one of the first and second projections of the first retainer overlaps with at least one of the first and second projections of the second retainer.

22. The resilient assembly of claim 19, wherein the first projection has a different length than the second projection.

23. The resilient assembly of claim 13, wherein the first and second retainers are formed from a sheet material.

24. The resilient assembly of claim 23, wherein the sheet material is sheet metal.

25. The resilient assembly of claim 13, wherein the resilient member is one selected from the group consisting of a spring, a tube of resilient material, and a block of resilient material.
